(19) United States
(12) Patent Application Publication
(10) Pub. No.: US 2006/0137013 A1
(43) Pub. Date: Jun. 22, 2006

(54) Quarantine filesystem

(76) Inventor: Simon Lok, New York, NY (US)

Correspondence Address: HOGAN & HARTSON LLP, ONE TABOR CENTER, SUITE 1500, 1200 SEVENTEENTH ST, DENVER, CO, 80202, US

(21) Appl. No.: 11/294,317

(22) Filed: Dec. 5, 2005

Related U.S. Application Data
(60) Provisional application No. 60/633,517, filed on Dec. 6, 2004.

(51) Int. Cl. G06F 12/14

(52) U.S. Cl. 726/24

(57) ABSTRACT

A quarantine filesystem driver having a first interface for communicating with an operating system library, a second interface for communicating with a primary filesystem, and a third interface for communicating with a secondary filesystem. Preferably the secondary filesystem is a delta filesystem that records a log of changes to data recorded in the primary filesystem. The primary filesystem couples to a primary mass storage device or devices that may be internal to (i.e., closely coupled to) the computing system in which the quarantine filesystem is implemented. The secondary filesystem couples to a mass storage system such as a hard disk drive that is independent of the primary mass storage device or devices. Most preferably the secondary mass storage device or devices is/are implemented externally to the system in which the quarantine filesystem is implemented.

### CROSS-REFERENCE TO RELATED APPLICATIONS

This application claims the benefit of U.S. Provisional Application No. 60/633,517, filed Dec. 6, 2004, which is incorporated herein by reference.

### BACKGROUND OF THE INVENTION

1. Field of the Invention

The present invention relates generally to data storage and filesystems, and more particularly, to a quarantine filesystem and associated method for effectively addressing the effects of malicious software and applications, such as viruses, backdoor trojans, and the like, in a data storage system or other computer system and/or network.

2. Background

With the expanding reliance on computers to store, access and manipulate information the importance of protecting the integrity of that information has become very significant. Information integrity can be compromised by physical and mechanical failures such as failure of hardware and/or communication channels that handle the data and programming code that represent the information. Increasingly, information integrity can be compromised intentionally by malicious code such as viruses, worms and the like that are loaded onto a computer system housing the data. Similarly, software bugs in applications and operating system (O/S) software may inadvertently affect information integrity by unexpected behavior.

A software or computer virus, including code referred to as a worm or trojan or other names, is a piece of program code, usually created by a malicious programmer, that may exist independently or may exist within or “infects” an otherwise normal computer program. When an infected program is run, the viral code seeks out other programs within the computer and may replicate itself. Infected programs can be anywhere in the system or even the operating system itself, and if undetected can have devastating effects, such as interfering with system operations or destruction of data. It is difficult for producers of computer software to design and produce products that are adequately secure against infection by such software viruses.

One approach used to combat virus problems is to use a separate program, external to the application programs being examined, to search through a computer's memory and disk storage for the characteristic pattern or signature of a known virus. Examples of products implementing this technique include Virex from MicroCom, Inc. (Durham, N.C.) and Viruscan from MacAfee Associates, Norton AntiVirus or NAV from Symantec Systems, Inc. among many others. The effectiveness of this approach is limited, however, by the fact that it depends on manually or automatically invoking the scanning software from time to time to scan the system. Computer users often fail to run such scans with sufficient frequency to prevent a virus from spreading. Moreover, such scans often require users to wait an unacceptable period of time while the entire system is scanned.

Another method to detect alteration of a program involves calculating a checksum value for the program being examined, and comparing it to the known checksum value of the original, pristine version of the program. When the program being examined has been infected by a computer virus or otherwise altered, the checksum value of the program will have changed as well. Examples of products implementing this method include Norton AntiVirus from Symantec Corp. and System Monitor from Rosenthal Engineering among others. This approach suffers from similar limitations in that it requires periodic and relatively frequent invocation of the software and may require the software to be run each time before running any of the user's programs.

Because malicious code is frequently transmitted in downloads from network sources such as web sites, electronic mail, file download and other common Internet activities, virus control software often includes the ability to scan data as it is downloaded either in email, instant messaging communications, file transfer communications and the like. Similarly, when new data and programs are loaded onto a computer from a disk, flash memory, or other source the material can be scanned for malicious code during the loading processes. These “inline” scanning techniques create a noticeable delay while content is scanned before the content becomes useable. Such scans ideally occur while downloaded data is resident in memory and before that data is loaded to a physical disk. Therefore, such in-memory scanning is impractical or impossible in some instances such as large files.

In conventional personal computer platforms physical mass storage is coupled to communicate with the filesystem resources implemented within or in conjunction with an operating system. A software application reads and writes to mass storage by making calls to the filesystem resources in the OS, which are in turn translated into bus-appropriate signals which are communicated to a physical storage device. Data and program code is loaded from disk into memory where code instructions are executed and data is manipulated to perform application specified functions. Mass storage is typically orders of magnitude larger than memory allowing significantly more complex programs and data to be handled than could be handled in memory alone. Because accessing mass storage is time consuming, overall system performance is often limited by mass storage response time. For this reason, conventional systems do not examine data communication between mass storage and the operating systems.

Overlay or union filesystems have been used to allow read-only volumes to appear to be writeable to an end-user. A common use for overlay or union filesystems is to allow an end-user to “modify” the contents of a CDROM, DVDROM or the like. These types of media are read-only and do not physically allow data to be changed on the media itself. The overlay or union filesystems create an illusion of manipulating the disk, as explained below. Even in the case of writeable media an overlay or union filesystem may be used to improve apparent performance to a user by delaying time consuming operations associated with writing to optical media and allowing the user to work more interactively with a faster hard disk drive during the delay period. Typically, an overlay or union filesystem is implemented as a virtual shim or stacked filesystem driver that resides between an underlying actual filesystem driver and the operating system library.

Recently, the personal computer world has seen growth in the use of virtualization and virtual machine monitoring. Products such as VMware are virtual machine monitors similar to what is shipped in mainframe computers. Other products such as VirtualPC are complete PC simulators that virtualize all of the hardware of a particular computer implementation such that operating system and application software execute as layers on top of the simulator without knowing whether they are executing on real or simulated hardware. These products are used for hardware and software testing and, as a result, they often include an “undoable” filesystem. An undoable filesystem allows the end user the ability to install and test software that may potentially damage a host without actually doing any damage. This feature is implemented as an application of the overlay or union filesystem concept to a writeable storage volume.

However, virtualization has not been employed in everyday computing as it impacts performance and/or requires greater hardware resources to achieve similar performance to conventional computer systems. As a result, features such as an undoable filesystem are used only in specialized environments where the need for such features outweighs the cost and performance penalty of the virtualization solution. Accordingly, a need exists for systems and methods for implementing features such as an undoable filesystem in a manner that minimally impacts performance of conventional computing systems, particularly personal computers.

### SUMMARY OF THE INVENTION

Briefly stated, the present invention involves a quarantine filesystem driver having a first interface for communicating with an operating system library, a second interface for communicating with a primary filesystem, and a third interface for communicating with a secondary filesystem. Preferably the secondary filesystem is a delta filesystem that records a log of changes to data recorded in the primary filesystem. The primary filesystem couples to a primary mass storage device or devices that may be internal to (i.e., closely coupled to) the computing system in which the quarantine filesystem is implemented. The secondary filesystem couples to a mass storage system such as a hard disk drive that is independent of the primary mass storage device or devices. Most preferably the secondary mass storage device or devices is/are implemented externally to the system in which the quarantine filesystem is implemented.

In operation, mass storage transactions are conducted such that transactions are first executed against the secondary filesystem. The secondary filesystem is continuously or frequently scanned to identify malicious code or other errors that might impact integrity of the system and/or data and program code stored in the primary filesystem. Data is only committed by implementing the changes stored in the secondary filesystem against the primary filesystem after the data stored in the secondary filesystem is determined to be safe. Because a user can continue accessing the data while the scanning and analysis occurs, any delay or latency associated with the scanning and analysis is hidden from the user. When data in the secondary filesystem is determined to be corrupted or compromised, the system can attempt to repair the damage or take other remedial action. In a worst case scenario the secondary filesystem can be disabled, removed, and replaced with a clean secondary filesystem and the primary filesystem will be unaffected by the malicious or corrupted code.

### BRIEF DESCRIPTION OF THE DRAWINGS

FIG. 1 shows a prior art filesystem architecture;

FIG. 2 shows a prior art union filesystem architecture; and

FIG. 3 shows a quarantine filesystem (QFS) architecture in accordance with an embodiment of the present invention.

### DETAILED DESCRIPTION

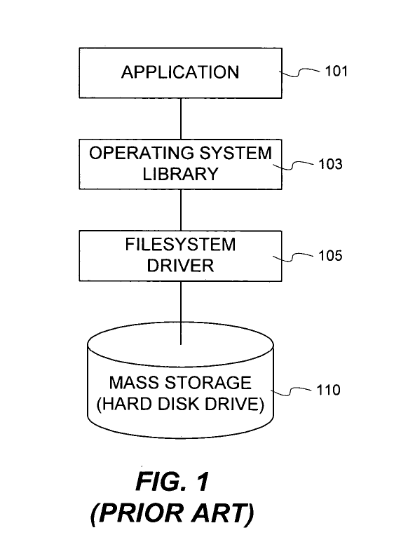

FIG. 1 shows a typical prior art system in which physical mass storage 110 is coupled so as to communicate with the filesystem resources 105 implemented within and/or in conjunction with the operating system 103. Mass storage 110 may be implemented by one or more physical devices such as hard disk drives that implement any of a number of industry standard interfaces such as ATA, SCSI, SATA, and the like, or a combination of these interfaces. Mass storage 110 may be implemented with RAID type mirroring and/or data protection if desired, and may be configured as a single volume of storage or multiple volumes of storage. This coupling between disk 110 and filesystem 105 is typically through one or more system buses such as a PCI bus, universal serial bus (USB), or the like.

A software application 101 uses mass storage 110 by making calls to the filesystem resources 105 through the operating system 103. These calls are in turn translated into bus-appropriate and interface appropriate signals which are communicated to a physical storage device 110. The prior art system shown in FIG. 1 is vulnerable to malicious or erroneous data/code on mass storage 110. Hence, great effort is made to try to ensure the integrity of everything that is stored in mass storage 110. As noted above, however, conventional tools such as virus scanning software are not completely effective for a variety of reasons.

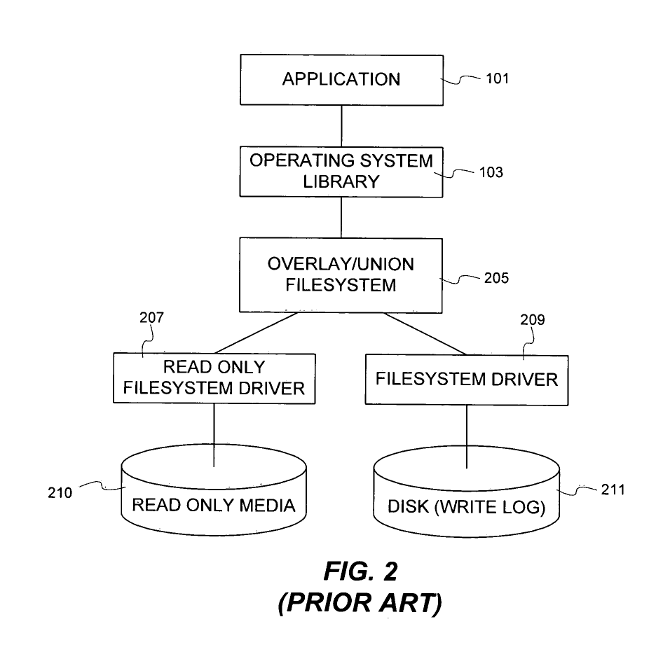

FIG. 2 shows a prior art overlay or union filesystem. Typically, an overlay or union filesystem is implemented as a virtual shim or stacked filesystem driver 205 that resides between an underlying actual filesystem drivers 207/209 and the operating system library 103.

In the case of an overlay/union implementation shown in FIG. 2, disk write operations from application 101 are communicated through OS 103 and are typically stored through filesystem 209 in a searchable log on a writeable volume 211 such as the computer's hard drive. Read operations are typically implemented in the overlay/union filesystem 205 by reading the underlying volume 210 from a read-only device such as a CDROM and then reading the appropriate portions of the write log implemented in read/write volume 211. These results are combined (hence the term “union”) in real time. The results of the combination are returned to the device implementing the application program 101 that generated the read command. For simplicity many implementations store entire files in the write log that are then overlaid on top of the original CDROM contents (hence the term “overlay”).

Undoable filesystems are similar to the union/overlay filesystem concepts, but differ in that the read only media 210 is a separate volume on the same writeable mass storage as the disk 211. Hence, there is a logical, but not physical, isolation between the write log and the primary mass storage. Accordingly, compromised data or program code in the write log is not physically separable from the primary filesystem. This configuration provides a convenience for application developers.

The present invention involves an evolution of the overlay filesystem concept methodology that builds on the “undoable” filesystem concept found in virtualization solutions. Unlike virtualization solutions that store a delta filesystem to a log file in a primary mass storage, the present invention uses a secondary mass storage that is preferably external and/or removable.

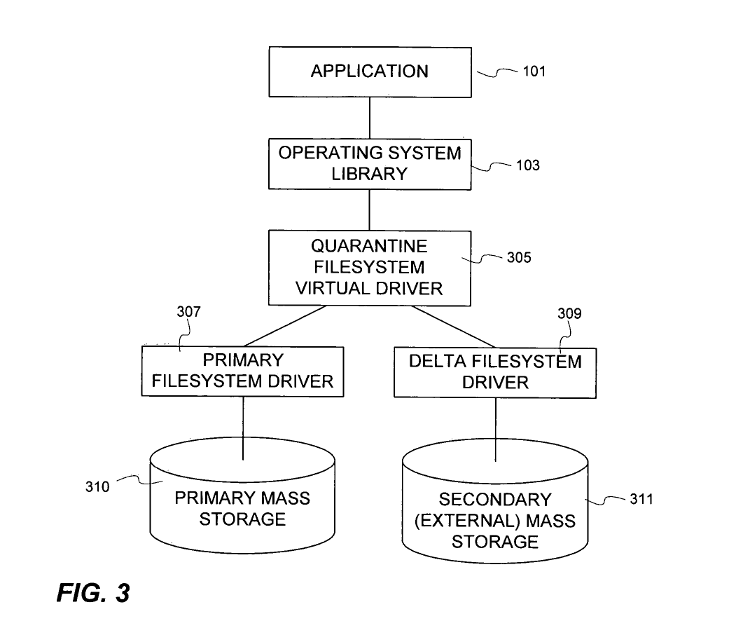

In this manner the present invention enhances the undoable filesystem concept with a tangible user interface in that the secondary storage can be physically and/or logically separated from the system without compromising the contents of the primary storage medium. As shown in FIG. 3, an application 101 communicates with an operating system library 103 in a conventional manner. The QFS 305 is installed as a driver delivered, for example, on a CDROM, flash ROM, or other secure media. The installation process places the QFS filesystem 305 as a shim between the OS library 103 and the underlying primary filesystem 307.

The shim approach will preferably imitate the implementation of virus protection software. Hence, application 101 and operating system 103 processes will not be affected by or require adaptation to quarantine filesystem driver 305.

In addition, the installation processes load delta filesystem driver 309 that optimizes storage of filesystem write differences by completely taking over secondary mass storage 311. Delta filesystem 309 is preferably implemented as a high performance driver meaning that it is optimized to the tasks associated with writing and reading file changes or deltas. Parameters that can be optimized include write size, read size, as well as logical formatting of the mass storage in terms of sector size and the like. The secondary mass storage device 311 can be configured to be used only for quarantine filesystem use so that it only stores differences or changes that are made to files stored on primary mass storage 310. Because the secondary mass storage 311 can be implemented for this dedicated purpose, the filesystem driver 309 can be somewhat more efficient. In contrast, primary filesystem driver 307 can be implemented as a more conventional, general purpose filesystem driver.

Secondary mass storage 311 may be implemented by a single hard disk drive, flash ROM, or other suitable memory devices. Secondary mass storage 311 may also be optimized for the specialized use as a delta filesystem by adjusting total storage size, masking storage areas used on the disk, selecting I/O cache and/or buffer size that improve performance. In specific embodiments secondary mass storage 311 is implemented as external storage devices that can be readily physically removed by a user. Such implementations provide a tangible user interface that enables corrupted data, malicious code and the like that has entered the system to be physically and logically separated from the primary mass storage 310.

With quarantine enabled, damage done by malicious software such as viruses, worms, and backdoor trojans is mitigated because nothing is actually written to the primary mass storage 310. When a problem is discovered at any time by automated tools such as conventional or special-purpose virus protection software or by the end user (e.g., a freeze up or “blue screen of death” on reboot), the user can readily detach the secondary external mass storage 311. Once detached, the quarantine filesystem delivers the original unmolested filesystem presented through primary filesystem driver 307 and primary mass storage 310.

After a user determines that a particular download is not causing problems and passes all antivirus checks, the user is able to “commit” a particular set of changes stored on the delta filesystem implemented by driver 309 and secondary storage 311 to the primary mass storage 310. The commit operation can be initiated by a user or initiated automatically or semi-automatically after appropriate scanning and analysis of the contents of secondary mass storage 311 is completed. Because the scanning and analysis of secondary mass storage 311 can occur asynchronously with respect to the normal usage of the computing system, the user does not experience long delays while file downloads are scanned or during delays before startup of applications.

I claim:

1. A quarantine filesystem driver comprising:
an operating system interface configured to communicate mass storage input/output transactions;
a primary filesystem interface configured to communicate with a primary filesystem driver; and
a secondary filesystem interface configured to communicate with a secondary filesystem driver.

2. The quarantine filesystem driver of claim 1 wherein the secondary filesystem comprises a delta filesystem.

3. The quarantine filesystem driver of claim 1 wherein the secondary filesystem is implemented using an external mass storage device that is physically separable from a system implementing the quarantine filesystem.

4. The quarantine filesystem driver of claim 1 further comprising processes within the quarantine filesystem driver to implement virus checking on contents of mass storage device coupled to the secondary filesystem.

5. The quarantine filesystem driver of claim 1 wherein the primary filesystem interface is not used for write operations until mass storage input output transactions that have been conducted through the secondary filesystem interface have passed security analysis.

6. The quarantine filesystem driver of claim 1 wherein the primary filesystem interface is operable to conduct input output transactions when the secondary filesystem interface becomes inoperable.

7. A quarantine filesystem comprising:
a primary mass storage device;
a secondary mass storage device;
an operating system having filesystem resources for implementing mass storage transactions between application software using the operating system and mass storage devices;
a quarantine filesystem shim in communication with the operating system;
a primary filesystem driver coupled to the quarantine filesystem shim and to the primary mass storage device; and
a delta filesystem driver coupled to the quarantine filesystem shim and to the secondary mass storage device.

8. The quarantine filesystem of claim 7 wherein the primary mass storage device is implemented as internal mass storage.

9. The quarantine filesystem of claim 7 wherein the secondary mass storage device is implemented as external mass storage.

10. The quarantine filesystem of claim 7 wherein the quarantine filesystem includes processes that enable the primary filesystem driver and primary mass storage to continue operation when the secondary mass storage is physically separated from the quarantine filesystem.

11. The quarantine filesystem of claim 7 wherein the operating system is unaware of a distinction between the internal and external mass storage devices.

12. The quarantine filesystem of claim 7 further comprising processes within the quarantine filesystem driver to implement virus checking on contents of mass storage device coupled to the secondary filesystem.

13. A computer system implementing the quarantine filesystem of claim 7.

14. A method of operating a filesystem comprising:
initiating a filesystem transaction in an operating system;
executing the filesystem transaction using an external storage device that is physically separable from the computer system implementing the filesystem;
analyzing the external storage device to confirm that the filesystem transaction will not adversely impact integrity of a primary filesystem; and
upon determining that the transaction will not adversely impact the primary filesystem, executing the filesystem transaction against the primary filesystem.
